(19) United States
(12) Patent Application Publication
(10) Pub. No.: US 2026/0197264 A1
(43) Pub. Date: Jul. 9, 2026

(54) AGENTLESS END-TO-END AGENT MONITORING IN MULTI-CLOUD NETWORK(S)

(71) Applicant: Cisco Technology, Inc., San Jose, CA (US)

(72) Inventors: William Mark Townsley, San Francisco, CA (US); Mark Alan Bakke, Maple Grove, MN (US); Nelson Jorge Silva Rodrigues, Walnut Creek, CA (US); Prabhnit Singh, San Francisco, CA (US)

(21) Appl. No.: 19/012,340

(22) Filed: Jan. 7, 2025

(51) Int. Cl. H04L 43/12; H04L 43/20

(52) U.S. Cl. CPC H04L 43/12; H04L 43/20

(57) ABSTRACT

Techniques for enabling streamlined and simplified management of connections across cloud service providers (CSPs). The techniques provide a new, decentralized multi-cloud mesh that integrates a cloud agent service within virtual points of presence (vPoPs) to provide agentless end-to-end monitoring of connection(s) for tenant accounts across CSPs. Users can configure test(s) that are executed by the vPoPs within the multi-cloud mesh, thereby reducing overhead of creating and maintain infrastructure. By integrating the cloud agent service into the vPoPs and deploying them within the multi-cloud mesh at the edges, the techniques enable test(s) to be performed between any network elements across CSPs and dramatically reduces infrastructure overhead, operational costs, and maintenance requirements.

### TECHNICAL FIELD

The present invention relates generally to cloud networking and more specifically to providing agentless end-to-end agent monitoring as a service across multi-cloud networks.

### BACKGROUND

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of networks, such as Local-Area Networks (LANs) that are in one physical location such as a building, Wide-Area Networks (WANs) that extend over a large geographic area to connect individual users or LANs, Enterprise Networks that are built for a large organization, Internet Service provider (ISP) Networks that operate WANs to provide connectivity to individual users or enterprises, software-defined networks (SDNs), wireless networks, core networks, cloud networks, and so forth.

An example network is a public cloud service provider (CSP). For instance, a customer (e.g., a tenant, such as a company or enterprise) environment can include a single CSP or multiple CPSs, such as AWS, Azure, Oracle, etc. The customer may use multiple CPS for a variety of reasons (e.g., specific features, mergers and acquisitions, dual-vendor policies, etc.). When using the CSPs, the customer may also still operate their private clouds and branches.

As an example, a customer may have workloads running in a single CSP (e.g., such as AWS). Additionally, the customer may have hundreds or even thousands of accounts or subscriptions associated with each of these workloads. For instance, a customer (e.g., such as a company) can have various teams (e.g., application teams, marketing teams, etc.). Each team can have multiple accounts within the CSP. Where the customer runs or has hundreds of teams, there can be thousands of accounts running in the single CSP, resulting in the customer needing infrastructure and IT support to run and maintain all of the accounts. Further, when the accounts of a customer are expanded across multiple cloud systems, various additional complexities and limitations are introduced that may differ between each cloud system.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an environment in which a system provides an example multi-cloud mesh that provides a simplified mechanism for managing multi-cloud connectivity between CSPs.

FIG. 2A illustrates a system-architecture diagram of an environment in which a cloud agent service is provided by the system described in FIG. 1 herein.

FIG. 2B illustrates a system-architecture diagram of an environment that illustrates exemplary probe pathways enabled by the techniques described herein.

FIG. 3 illustrates an example environment 300 that includes a CNHE 216 that may be generated according to the techniques described herein.

FIG. 4 illustrates a flow diagram of an example system 400 for providing an agentless end-to-end monitoring service in a multi-cloud network (MCN), according to the systems and techniques described herein.

FIG. 5 illustrates a flow diagram of an example system 400 for providing an agentless end-to-end monitoring service in a network management system (NMS) of a multi-cloud network (MCN), according to the techniques described herein.

FIG. 6 is a computer architecture diagram showing an illustrative computer hardware architecture for implementing a device that can be utilized to implement aspects of the various technologies presented herein.

### DESCRIPTION OF EXAMPLE EMBODIMENTS

### Overview

The present disclosure relates generally to the field of cloud networking and more specifically to providing agentless end-to-end agent monitoring as a service across multi-cloud networks. For instance, the techniques described herein may relate to utilizing a network management system (NMS) to provide the agentless end-to-end monitoring across CSPs as a service within the multi-cloud network (MCN).

A method to perform the techniques described herein may include receiving, by a virtual point of presence (vPoP) within a service provider account of a cloud service provider (CSP) of the MCN, input associated with a test of a network element within a tenant account of the CSP. The method may include generating, by the vPoP, one or more probes associated with the test of the network element. The method may also include sending, by the vPoP and to the network element within the tenant account, the one or more probes. The method may include determining, based on the one or more probes, a status of a connection to the network element. The method may also include sending, based on the status, output to a dashboard of a service provider of the MCN.

Another method to perform the techniques described herein may include generating virtual points of presence (vPoPs) comprising instances of a cloud agent, the cloud agent executing within the NMS. The method may include determining a test of one or more connections associated with a tenant account, the test being performed by an instance of the cloud agent at a vPoP. The method may also include receiving data associated with execution of the test by the vPoP. The method may include determining a status of the tenant account based on the data. The method may further include outputting a message in association with the tenant account, the message including the status.

Additionally, any techniques described herein, may be performed by a system and/or device having non-transitory computer-readable media storing computer-executable instructions that, when executed by one or more processors, performs the method(s) described above and/or one or more non-transitory computer-readable media storing computer-readable instructions that, when executed by one or more processors, cause the one or more processors to perform the method(s) described herein.

### Example Embodiments

As noted above, the use of multiple CSPs introduces various complexities for customers. Some complexities may relate to managing a customer network over multiple cloud networks. One such complexity relates to connecting different workloads and CSPs. As each cloud system has different components, connecting between cloud system(s) and the customer's private clouds and branches is difficult. For instance, a customer may want to deploy an application in two separate CSPs (e.g., such as AWS and Azure). However, how the two CSPs are structured, perform tagging, name components, etc. can be very different. This is not only highly complex but requires specialty knowledge in networking for both CSPs to enable network elements from one CSP to connect to network elements from another CSP, resulting in a need to hire staff that specialize in each CSP. Accordingly, managing the customer network can be resource intensive, complex, and costly for the customer to track and maintain.

Additionally, complexities can relate to inconsistencies between the different CSPs. For instance, each CSP may have inconsistencies in the capabilities between each CSP and the sites of the customer. Each CSP may have differences in the limitations of components between each CSP and networking elements of the customer. One such limitation may relate to how each CSP tags various cloud objects. These inconsistencies also increase the complexity of providing security and observability to the customer in an end-to-end integration between CSPs. For instance, providing connectivity between different firewalls and security features of different CSPs can be complex as permissions may differ or conflict and addresses between network elements may overlap. These inconsistencies also increase the complexity of providing security and observability to the customer in an end-to-end integration between CSPs. Thus, managing multiple CSPs for a company is difficult, costly, and resource intensive.

Moreover, complexities can relate to identifying when connections go down. For instance, some existing techniques may utilize a cloud agent to test various connections. However, existing techniques that utilize cloud agents are not configured to run in a multi-cloud network and require thousands of instances of the cloud agent to be deployed within customer networks and the CSP. For instance, each VPC a customer runs within a CSP would run a separate instance of the cloud agent and needs a separate subscription to the cloud agent provider. Further, the customer is charged for each test each instance of the cloud agent executes. Accordingly, running each instance of the cloud agent in a separate VPC (or VNET) of a CSP results in a large amount of network resources being used by the cloud agent. Where the customer has thousands of VPCs or accounts, scalability of existing systems is difficult and costly as existing infrastructure does not support the integration of a cloud agent. Further, each test run by an instance of an agent can result in a cost to the customer. Accordingly, running or executing tests across thousands of instances of the agent can be expensive to the customer and utilize large amounts of CPU. Additionally, expenses can be high due to the tests needing to be manually configured for each of the cloud agent instances, resulting in large amounts of time and resources being spent by the customer on infrastructure and personnel. Moreover, the use of the agent may differ between CSPs, and may be internet focused, such that the cloud agent is not configured to run within the customer's private network.

Accordingly, a simplified way to test and provide observability of connections to the customer in an end-to-end integration between CSPs is needed.

This disclosure describes techniques for providing an agentless end-to-end monitoring service in a multi-cloud network (MCN). In some examples, the techniques include receiving, by a virtual point of presence (vPoP) within a service provider account of a cloud service provider (CSP) of the MCN, input associated with a test of a network element within a tenant account of the CSP. The techniques may include generating, by the vPoP, one or more probes associated with the test of the network element. The techniques may also include sending, by the vPoP and to the network element within the tenant account, the one or more probes. The techniques may include determining, based on the one or more probes, a status of a connection to the network element. The techniques may also include sending, based on the status, output to a dashboard of a service provider of the MCN.

This disclosure also describes techniques for providing an agentless end-to-end monitoring service in a network management system (NMS) of a multi-cloud network (MCN). The techniques may include generating virtual points of presence (vPoPs) comprising instances of a cloud agent, the cloud agent executing within the NMS. The techniques may include determining a test of one or more connections associated with a tenant account, the test being performed by an instance of the cloud agent at a vPoP. The techniques may also include receiving data associated with execution of the test by the vPoP. The techniques may include determining a status of the tenant account based on the data. The techniques may further include outputting a message in association with the tenant account, the message including the status.

In some examples, the system provides the ability to have a single network management system (NMS) and a method of operation across the CSPs in a multi-cloud network (MCN), so that the customer can run workloads in their cloud of choice for various reasons (e.g., cost, capabilities, mergers/acquisitions, etc.). In some examples, the system may operate gateways in all of the availability zones of all of the CSPs, such that the system may provide MCN management as a service. For instance, the service may correspond to the NMS that includes a dashboard (e.g., such as a Meraki dashboard) and/or is implemented as an application (e.g., such as a SaaS app) that interfaces with a user device of the customer. In some examples, the system may utilize a gateway of a service provider (e.g., such as a Cisco native gateway) instead of a gateway associated with the CSP. The system may be configured to set up encrypted tunnels between all the different gateways in order to route the traffic over the internet and between CSPs.

In some examples, the system includes virtual points of presence (vPoPs). In some examples, the vPoPs comprise cloud native head end (CNHE) vPoPs and may represent an end point that the customer talks to and/or connects to. For instance, the system may utilize a multi-tenant cloud-native headend (CNHE). In some examples, the CNHE may be located within a customer networking topology. In the techniques described herein, the CNHE is located within the multi-cloud mesh. In some examples, the system may utilize the CNHE to provide multitenancy to the vPoPs by enabling segmentation of traffic into independent VRFs, such that data packets from multiple tenants are processed by the same data node instance.

The vPoPs are multi-tenanted, such that multiple customers may connect to a single vPoP. In some examples, the vPoPs are deployed within the MCN (e.g., a mesh interconnect), such as within a CNHE virtual private cloud (VPC) or a CNHE virtual network (VNET). For instance, the vPoPs may be deployed within regions of Azure, AWS, Oracle, etc. that are owned by a service provider (e.g., such as Cisco), thereby providing the system with improved latency characteristics and enabling the system to leverage specific functionalities of each CSP. Thus, by utilizing CNHE vPoPs, the system may provide lightweight vPoPs that can be located anywhere (e.g., such as within a cloud) and can be set up of a in a new region within minutes. Accordingly, the vPoPs deployed by the system are outside of the CSP regions that are owned by the customer (e.g., and instead are deployed in VPCs/VNETs of the service provider), such that the system is not deploying code, virtual machines, instances, etc. of the vPoPs to the customer network(s), thereby enabling the customer to implement the system without having to allocate additional network resources (e.g., CPU, memory, etc.) of network devices, or increasing costs to the customer. Moreover, by deploying the vPoPs within the MCN, the system is configured to handle software upgrades, security tickets, etc. on behalf of the customer, such that the customer does not need to see or handle updates or security tickets for thousands of accounts. In some examples, the vPoPs are configured to provide connections between one or more of Amazon Web Service (AWS) VPCs, Azure VNETs, Google Cloud Platform (GCP) VPCs, Meraki AutoVPN sites, Catalyst IPsec SD-WAN sites, or any other virtual, cloud, or on-premise connection.

In some examples, the system may be configured to keep one or more of data traffic, routes, statistics, etc. of different tenants separate from each other. For instance, the vPoP(s) may be configured to separate and hook together traffic, data, routes, statistics, etc. In some examples, the vPoPs may be configured to connect the tenancies (e.g., all of Tenant A together, all of Tenant B together, etc.). Each vPoP may be configured to transmit data to each other over the internet, or other cores (e.g., such as a 100 GB core). Accordingly, the system may be configured to provide a per customer topology between the vPoPs that is automated, provides flexibility in the types of tunnels, use of single or multiple tunnels, and/or providing balancing across the tunnels when needed (e.g., such as to get around administration limitations).

In some examples, the system may provide a cloud agent service (e.g., also referenced as a multi-tenanted cloud agent, a cloud agent, or instance(s) of a cloud agent) within the MCN that enables agentless end-to-end agent monitoring across CSPs in the MCN. For instance, the cloud agent service may correspond to ThousandEyes or any other suitable probing service. As an example, existing enterprise agent services (e.g., such as ThousandEyes) may charge customers based on the tests that are run. The enterprise agent service may have enterprise agents that can be deployed in the customer's infrastructure as a virtual machine and/or in a datacenter. The enterprise agents may perform synthetic tests that are customizable by the customer. In some instances, the customer can install an enterprise agent in a VPC. However, there is overhead to install, maintain, update, and manage each enterprise agent. Further, each VPC may need a separate subscription to the enterprise agent service. Thus, since the enterprise agent can be deployed in the customer's network as a VPC, the customer is required to maintain/manage the agent, which can be costly, time consuming, etc., and can be unmanageable where there are thousands of accounts and subscriptions needed.

Further, existing enterprise agent services may operate cloud agents that are installed in various locations around the world. Customers can schedule tests to be run from the cloud agents in a similar manner as an enterprise agent. However, under existing techniques, the cloud agents only have reachability over the global internet. As such, the tests cannot be run on the customer's internal networks.

Unlike existing techniques and existing enterprise agent services, the system described herein may integrate the cloud agent within the CNHE itself and may map time-based multiplexing for tests from a cloud agent with the traffic segmentation within the CNHE. The system may allow a customer to schedule a test from a cloud agent within their own network infrastructure rather than over the Internet alone.

In some examples, the system may be configured to integrate the multi-tenanted cloud agent into a CNHE vPoP. For instance, the system may provide multi-tenancy for probes (e.g., tests) run across CSPs. The system may configure the CNHE to separate traffic for each tenant via segmented routing of traffic from the customers. The system may map the segmentation performed by the CNHE to the time division multiplexing used for scheduling probes by the cloud agent. Accordingly, unlike existing techniques where a cloud agent could only deploy a probe via the Internet, the system may enable a cloud-based probe running in a CNHE of the multi-cloud mesh to access the entire customer environment for a particular tenant.

In some examples, the system may include a dashboard. The dashboard may be configured to interface with one or more user devices of customers (e.g., tenants). For instance, the dashboard may be deployed as part of a network management system (NMS) within the multi-cloud mesh. In some examples, the dashboard may be deployed separately from the NMS and may interface with the NMS via one or more application programming interfaces (APIs). In some examples, the dashboard may be installed next to a data plane of the multi-cloud mesh, such as at an edge. In some examples, the dashboard may be installed at the edge of the multi-cloud mesh, such that it is a single hop away from a customer network. In some examples, the dashboard may include the multi-tenanted cloud agent configured to provide probing services to tenant(s) across the MCN. In some examples, instances of the cloud agent are deployed within CNHE vPoPs and/or CNHE VNETs, such that the NMS may manage and maintain each instance of the cloud agents.

In some examples, the dashboard may be configured to enable a user (e.g., such as a network administrator of a customer or any other suitable user) to configure and/or deploy tests. Accordingly, the system may enable a customer to customize, configure, and run similar tests as they could in a service such as ThousandEyes, but it would come from that single agent instance. The agent instance may be configured to send and/or respond to the synthetic tests. In some examples, the tests may be configured to be performed at a time interval (e.g., every 2 seconds, 5 seconds, or any other suitable interval). The dashboard may generate and output alerts when a test fails. For instance, where a connection to a particular network element (e.g., such as a subnet) fails, the system may generate an alert that notifies the customer that traffic to the subnet is not getting through. This can enable the customer to perform remedial actions and shorten the time period a connection is offline or down. In some examples, the customer may configure tests for connectivity between one or more of: VPC(s) to VNET(s) across the MCN, endpoint(s) to a CSP, an external or remote application into the edge of the VPC, between subnet(s), etc. In some examples, a service provider of the multi-cloud mesh (e.g., such as Cisco) may utilize the cloud agent as a tenant. For instance, the service provider may utilize the cloud agent to test connectivity between probe(s), edge to edge, infrastructure, and more. Accordingly, the service provider can be a tenant of itself.

In some examples, the system may include an intelligence component. In some examples, the intelligence component may be configured to identify address(es) of customer's network to use when performing a test. For instance, the intelligence component may be configured as part of the NMS and/or deployed as part of a CNHE, a vPoP, etc. within the multi-cloud mesh. The intelligence component may be configured to receive customer data, statistics, etc. from the vPoPs. The intelligence component may be configured to monitor connections within a customer account at a CSP. In some examples, the intelligence component may be configured to determine (e.g., based on the data, access, monitoring the connections, etc.) one or more subnet(s) and/or IP address(es) within the customer account of the CSP that are unused or not currently being used by the customer account. In some examples, the intelligence component may select one of the unused subnet(s)/IP address(es) that can be used by a vPoP when performing a probe via an instance of the cloud agent. In this example, when the dashboard sends a test to a vPoP to be performed, the CNHE/vPoP may send the probe using the unused subnet/IP address as the source address for the probe. Thus, the system may ensure that the probe that is sent appears to be running on a VPC or VNET within the customer account of a CSP and may therefore apply the appropriate firewall policies and/or other policies to the probe. In some examples, the system is configured to utilize the unused subnet/IP address temporarily (e.g., tests that are run a few times, but are not permanent or run consistently over a long period of time (e.g., weeks, months, etc.). In other examples, such as where a test is run consistently over a long period of time, the system may reserve a subnet/IP address. In this example, the system may create a network interface to reserve the IP address on the subnet from the customer account and may use the IP address for the probe associated with the subnet. Thus, by reserving a single IP address for each subnet within the customer account the system can perform probing for all of the subnets across CSPs.

In some examples, such as where a probe is configured to test from an external or remote application into an edge of the customer account of the CSP, the system may provide the unused subnet/IP address to the external or remote application for use when sending the probe. In this example, the system may configure the probe to include a functionality that enables the vPoP to answer the probe.

In some examples, the intelligence component may be configured to utilize one or more artificial intelligence and/or machine learning model(s) to generate recommendation(s) of test(s) and/or configure test(s) on behalf of the customer. For instance, the intelligence component may be configured to analyze the data (e.g., using the model(s)) and determine patterns or intent of connectivity (which is enforced by the CNHEs) between the CSPs for a customer. The intelligence component may, based on the patterns and/or intent of connectivity generate a set of tests to recommend to the customer to use to test if a configuration is or is not working as designed. As an example, the intelligence component may generate a recommendation of a test to run in response to someone trying to change or update a tag within a customer account. In other examples, the intelligence component may recommend the customer adopt a rule that where the customer creates a new application, the system may run test(s) the next day to make sure connections are working correctly. In some examples, the intelligence component may be configured to automatically turn tests on or off. For instance, the tests to check connections of an application can be turned on when the system detects a new application is deployed or connected to the multi-cloud mesh. In another example, such as where the customer configures a change to one or more firewall rules, the intelligence component may automatically turn on the tests for a set period of time (e.g., 20 minutes, 30 minutes, etc.) and then automatically turn the tests off.

Thus, by integrating a multi-tenanted cloud agent within a data plane of the multi-cloud mesh and deploying instances of the multi-tenanted cloud agent as part of a vPoP that is not located within the customer network, the system may enable tests to be run without the overhead of installing and maintaining an enterprise agent within the customer infrastructure, thereby reducing CPU, memory, and bandwidth within the customer network. Moreover, unlike existing enterprise agents, the system may provide cloud agents that are multi-tenanted within the MCN, such that one agent can serve many customers. In some examples, this may be accomplished via a time-based scheduling of tests for each customer from the same agent, which improves efficiency, saves resources, and reduces costs compared to running an enterprise agent per customer. Further, by integrating the cloud agent within the CNHE vPoP and deploying the vPoP within the multi-cloud mesh, the system may enable the cloud agents the ability to probe any connection within a customer's private network, across CSPs. Further, unlike existing cloud agents which are limited in reachability to the Internet from one of the installed locations, the system may enable the cloud agent to access the customer's private networks, thereby extending and improving the capabilities of existing techniques. Further, by utilizing the CNHEs, the system may provide a multi-tenanted system that can be implemented on a large scale, such that adding new customers (e.g., tenants) and scaling requires little to no additional resources.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

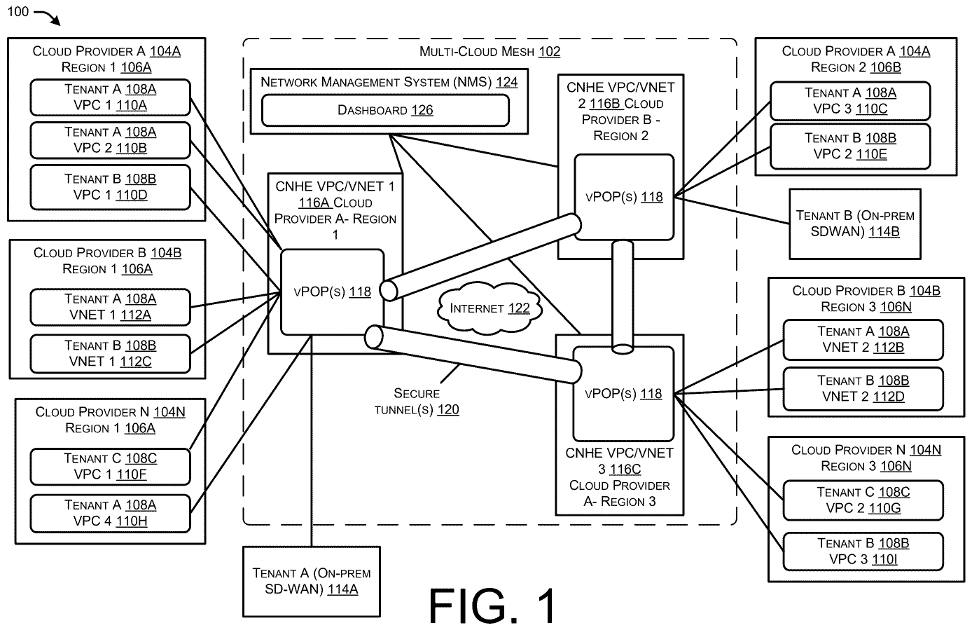

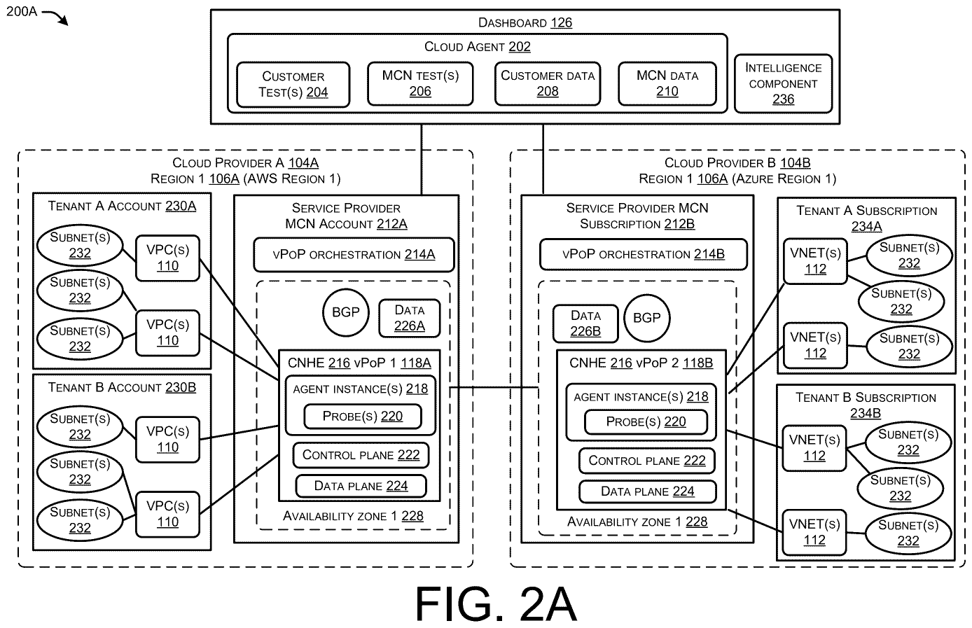

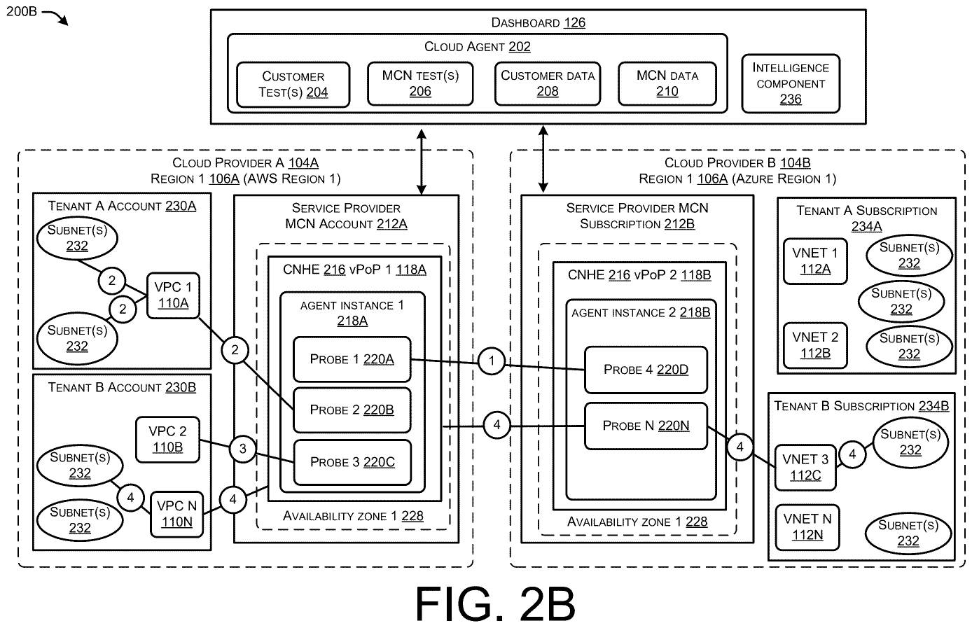

FIG. 1 illustrates a system-architecture diagram of an environment in which a system 100 provides an example multi-cloud mesh that provides a simplified mechanism for managing multi-cloud connectivity between CSPs. While the system 100 shows an example multi-cloud mesh, it is understood that any of the components of the system may be implemented on any device, network, and/or any cloud-based service provider. Moreover, while the system 100 does not illustrate a network management system, it is understood that any of the components illustrated in FIGS. 2A-6 may be implemented and/or incorporated in the multi-cloud mesh. Moreover, while the techniques described herein are described in relation to probing the MCN, it is understood that they may apply or be integrated into security cloud service(s), or any other suitable cloud service.

In some examples, the system 100 may include multi-cloud mesh 102. As used herein, multi-cloud mesh 102 may be referenced as the “MCN” and vice versa. The multi-cloud mesh 102 may include one or more networks implemented by any viable communication technology, such as wired and/or wireless modalities and/or technologies. The multi-cloud mesh 102 may include any combination of Personal Area Networks (PANs), SDCI, Local Area Networks (LANs), Campus Area Networks (CANs), Metropolitan Area Networks (MANs), extranets, intranets, the Internet, short-range wireless communication networks (e.g., ZigBee, Bluetooth, etc.), Wide Area Networks (WANs) - both centralized and/or distributed, SD-WANs, SDNs—and/or any combination, permutation, and/or aggregation thereof. The multi-cloud mesh 102 may include devices, virtual resources, or other nodes that relay packets from one network segment to another by nodes in the computer network. The multi-cloud mesh 102 may include multiple devices that utilize the network layer (and/or session layer, transport layer, etc.) in the OSI model for packet forwarding, and/or other layers. In some examples, the multi-cloud mesh 102 correspond to an SD-WAN overlay.

The system 100 may comprise cloud provider(s) (e.g., cloud provider A 104A, cloud provider B 104B, cloud provider N 104N), which may correspond to various CSPs. For instance, cloud provider A 104A may represent AWS, cloud provider B 104B may represent Azure, and cloud provider N 104N may represent GPC.

Each cloud provider may have one or more site(s) associated with a particular region (e.g., region 1 106A, region 2 106B, region 3 106N, etc.). For instance, region 1 106A may represent a western portion of a particular geographic location (e.g., country, state, city, or any other suitable geographic location), region 2 may represent a central portion of the geographic location, and region 3 106N may represent an eastern portion of the geographic location.

The site(s) may comprise data centers, which may be physical facilities or buildings located across geographic areas that are designated to store networked devices that are part of a manufacturer. The data centers may include various network devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples, the devices in the packet-forwarding networks may not be located in explicitly defined data centers but may be located in other locations or buildings. In some examples, the site(s) comprise network device(s), which may correspond to any computing device, routers, switches, computers, or any other type of network device. Edge device(s) may comprise routers, switches, access points, stations, radios, and/or any other network device.

Each cloud provider may be multi-tenanted. For instance, cloud provider A 104A in region 1 106A may provide services to Tenant A 108A and Tenant B 108B. Each tenant may correspond to a different customer (e.g., such as an enterprise, organization, private entity, etc.). As illustrated, tenant A 108A may utilize services provided by cloud provider A 104A, cloud provider B 104B, and cloud provider N 104N. For instance, the services may include virtual private clouds (VPC(s) 110) or virtual networks (VNET(s) 112) that each respective tenant pays the cloud service provider for. As illustrated, the services provided by each cloud provider to each respective tenant is located outside of the multi-cloud mesh 102.

As illustrated in FIG. 1, cloud provider A 104A may run various VPCs for each tenant in each region. For instance, for tenant A 108A, cloud provider A 104A may run VPC 1 110A and VPC 2 110B in region 1 106A and VPC 3 110C in region 2 106B. For tenant B, cloud provider A 104A may also run VPC 1 110D in region 1 106A and VPC 2 110E in region 2. Similarly, cloud provider B 104B may be configured to provide VNET services to tenants. As illustrated for tenant A 108A, cloud provider B 104B may run VNET 1 112A in region 1 106A and VNET 2 112B in region 3 106N. For tenant B, cloud provider B 104B may run VNET 1 112C in region 1 106A and VNET 2 112D in region 3 106N. Cloud provider N may also be configured to provide VPC services. For instance, for tenant C 108C, cloud provider N 104N may provide VPC 1 110F in region 1 106A and VPC 2 110G in region 3. For tenant A, cloud provider N 104N may provide VPC 4 110H in region 1. For tenant B, cloud provider N may provide VPC 3 110I in region 3.

Additionally, each tenant may have one or more physical location(s). For instance, Tenant A 108A may have an on-premises SD-WAN 114A. In some examples, the tenant A on-premises SD-WAN 114A may comprise a site or physical data center of tenant A. In some examples, the tenant A on-premises SD-WAN 114A may utilize features or protocols to connect to the multi-cloud mesh 102, such as Meraki and/or AutoVPN. Tenant B 108B may have an on-premises SD-WAN 114B. In some examples, the tenant B on-premises SD-WAN 114B may comprise a site or physical data center of tenant B and may be located in region 2. In some examples, the tenant B on-premises SD-WAN 114B may utilize features or protocols to connect to the multi-cloud mesh 102, such as Cisco's Catalyst IPsec and/or ISR.

The multi-cloud mesh 102 may comprise network management system (NMS) 124. The NMS 124 may correspond to a system that has complete visibility into the fabric of a given network. In some examples, the NMS 124 may comprise one or more controllers, one or more processors, memory, one or more APIs, one or more applications, one or more components, etc. In some examples, and as described in greater detail below, the NMS 124 may be configured to generate cloud formation templates and vPoP(s) 118. As illustrated in FIG. 1, the NMS 124 may be connected to one or more CNHE VPC/VNET(s) 116 that comprise vPoP(s) 118, such that the NMS 124 can monitor, manage, and update each vPoP.

In some examples, the NMS 124 may comprise dashboard 126. In some examples, the dashboard 126 may include a cloud agent service (e.g., such as ThousandEyes). The may be configured to interface with one or more user devices of customers (e.g., tenants). For instance, the dashboard may be deployed as part of a network management system (NMS) within the multi-cloud mesh. In some examples, the dashboard may be deployed separately from the NMS and may interface with the NMS via one or more application programming interfaces (APIs). In some examples, the dashboard may be installed next to a data plane of the multi-cloud mesh, such as at an edge. In some examples, the dashboard may be installed at the edge of the multi-cloud mesh, such that it is a single hop away from a customer network. In some examples, the dashboard may include the multi-tenanted cloud agent configured to provide probing services to tenant(s) across the MCN. In some examples, instances of the cloud agent are deployed within CNHE vPoPs and/or CNHE VNETs, such that the NMS may manage and maintain each instance of the cloud agents.

In some examples, the dashboard may be configured to enable a user (e.g., such as a network administrator of a customer or any other suitable user) to configure and/or deploy tests. Accordingly, the system may enable a customer to customize, configure, and run similar tests as they could in a service such as ThousandEyes, but it would come from that single agent instance. The agent instance may be configured to send and/or respond to the synthetic tests. In some examples, the tests may be configured to be performed at a time interval (e.g., every 2 seconds, 5 seconds, or any other suitable interval). The dashboard may generate and output alerts when a test fails. For instance, where a connection to a particular network element (e.g., such as a subnet) fails, the system may generate an alert that notifies the customer that traffic to the subnet is not getting through. This can enable the customer to perform remedial actions and shorten the time period a connection is offline or down. In some examples, the customer may configure tests for connectivity between one or more of: VPC(s) to VNET(s) across the MCN, endpoint(s) to a CSP, an external or remote application into the edge of the VPC, between subnet(s), etc. In some examples, a service provider of the multi-cloud mesh (e.g., such as Cisco) may utilize the cloud agent as a tenant. For instance, the service provider may utilize the cloud agent to test connectivity between probe(s), edge to edge, infrastructure, and more. Accordingly, the service provider can be a tenant of itself.

The CNHE VPC/VNET(s) 116 may correspond to a VPC or a VNET that is owned and/or managed by a service provider of the NMS (e.g., such as Cisco). As illustrated in FIG. 1, each CNHE VPC/VNET may be deployed within a particular cloud service provider and/or region. For instance, CNHE VPC/VNET 1 116A may run in cloud provider A region 1, CNHE VPC/VNET 2 116B may run in cloud provider B region 2, and CNHE VPC/VNET 3 116C may run in cloud provider A region 3. Accordingly, where cloud provider A represents AWS, CNHE VPC/VNET 1 116A and CNHE VPC/VNET 3 116C may represent instances of VPCs running in AWS. Where cloud provider B represents Azure, CNHE VPC/VNET 2 116B may represent instances of a VNET running in Azure. While the CNHE VPC/VNET(s) are illustrated as being run in different cloud providers, it is understood that a single CSP may be used or additional CSPs may be used.

As illustrated in FIG. 1, the vPoP(s) 118 in CNHE VPC/VNET 1 116A is configured to connect to each VPC and VNET running in cloud provider A 104A, cloud provider B 104B, and cloud provider N 104N in region 1 106A. Additionally, the vPoP(s) 118 in CNHE VPC/VNET 1 116A may be configured to connect to Tenant A on-premises SD-WAN 114A using various protocols. The vPoP(s) 118 in CNHE VPC/VNET 2 116B is configured to connect to each VPC and VNET running in each cloud provider in region 2 106B. Additionally, the vPoP(s) 118 in CNHE VPC/VNET 2 116B may be configured to connect to Tenant B on-premises SD-WAN 114B using various protocols. The vPoP(s) 118 in CNHE VPC/VNET 3 116C is configured to connect to each VPC and VNET running in each cloud provider in region 2 106B. Additionally, the vPoP(s) 118 in CNHE VPC/VNET 2 116B may be configured to connect to Tenant B on-premises SD-WAN 114B using various protocols.

As illustrated, the vPoP(s) 118 are connected using secure tunnel(s) 120, which may represent encrypted data tunnels or tunnels created using any secure tunneling protocol. In some examples, the secure tunnel(s) 120 may be associated with a connection determined by a tenant, such that traffic from different tenants may be routed according to different protocols. Further, as illustrated, the vPoP(s) may be configured to communicate over the internet 122 or any other suitable network connection (e.g., core(s), 100 GB core, etc.).

In some examples, the vPoP(s) 118 comprise cloud native head end (CNHE) vPoPs and may represent an end point that the customer talks to and/or connects to. The vPoPs are multi-tenanted, such that multiple customers may connect to a single vPoP. In some examples, the vPoPs are deployed within the MCN (e.g., a mesh interconnect), such as within a CNHE virtual private cloud (VPC) or a CNHE virtual network (VNET). For instance, the vPoPs may be deployed within regions of Azure, AWS, Oracle, etc. that are owned by a service provider (e.g., such as Cisco), thereby providing the system with improved latency characteristics and enabling the system to leverage specific functionalities of each CSP. Thus, by utilizing CNHE vPoPs, the system may provide lightweight vPoPs that can be located anywhere (e.g., such as within a cloud) and can be set up in a new region within minutes.

Accordingly, the vPoPs deployed by the system are outside of the CSP regions that are owned by the customer (e.g., and instead are deployed in VPCs/VNETs of the service provider), such that the system is not deploying code, virtual machines, instances, etc. of the vPoPs to the customer network(s), thereby enabling the customer to implement the system without having to allocate additional network resources (e.g., CPU, memory, etc.) of network devices, or increasing costs to the customer. Moreover, by deploying the vPoPs within the multi-cloud mesh 102, the NMS 124 is configured to handle software upgrades, security tickets, etc. on behalf of the customer, such that the customer does not need to see or handle updates or security tickets for thousands of accounts.

In some examples, the vPoPs 118 are configured to provide connections between one or more of Amazon Web Service (AWS) VPCs, Azure VNETs, Google Cloud Platform (GCP) VPCs, Meraki AutoVPN sites, Catalyst IPsec SD-WAN sites, or any other virtual, cloud, or on-premise connection.

In some examples, the vPoP(s) 118 and/or NMS 124 may be configured to keep one or more of data traffic, routes, statistics, etc. of different tenants separate from each other. In some examples, the vPoP(s) 118 may be configured to connect the tenancies (e.g., all of Tenant A together, All of Tenant B together, etc.). Each vPoP may be configured to transmit data to each other over the internet 122, or other cores (e.g., such as a 100 GB core). Accordingly, the system may be configured to provide a per-customer topology between the vPoPs that is automated, provides flexibility in the types of tunnels, improved throughput, flexibility in the number of tunnels used (e.g., single or multiple tunnels), and/or provides balancing across the tunnels when needed (e.g., such as to get around administration limitations).

Thus, the multi-cloud mesh 102 may be configured to provide a connectivity first architecture (versus a security first architecture that runs everything through a firewall). As used herein, “connectivity first” means some of the security features of the multi-cloud mesh 102 is based on the connections selected by each tenant. For example, tenant A 108A can choose to connect VPC 1 110A and VPC 3 110C, but nothing else. In this example, the NMS 124 may distribute the routes for connecting VPC 1 110A and VPC 3 110C and may ensure that traffic sent/received by VPC 1 110A is to/from VPC 3 110C and vice versa. In some examples, the NMS 124 may distribute stateless firewalls to edge device(s) within the multi-cloud mesh 102, such that the techniques may not need to provide a central service all the time.

In this way, the system may provide a simplified way to manage multi-cloud connectivity between CSPs (Azure, AWS, Oracle, etc.). For instance, the system creates a new, decentralized architecture that utilizes vPoPs that are deployed within VPCs or VNETs of different CSPs, which provides the system with improved latency characteristics, and enables the system to leverage specific functionalities of each CSP when forming connections, routing traffic, etc., resulting in optimized traffic flow and reduced costs to the customer. By utilizing vPoPs that are lightweight and can be located anywhere, the system provides a way to form a new connection by setting up a new vPop in a new region within minutes, reducing latency for the customer and streamlining connection management. Further, by including lightweight security built into the vPoPs (e.g., such as ACLs, stateless actions), with hand offs of heavier features (e.g., such as deep packet inspection), the system can provide secure connections that leverage functionalities within each CSP. Accordingly, the system may automatically generate connections between a customer network and the MCN, thereby reducing complexity, infrastructure, and cost to the customer. Moreover, the system automatically handles routing (optimized for the customer based on various factors), firewalling, etc. without the customer needing to provide input (e.g., without the customer even providing an IP address), thereby streamlining connection management and reducing the number of communications between the system and the customer or API, thereby improving bandwidth and freeing up other network resources available within the MCN.

FIG. 2A illustrates a system-architecture diagram of an environment 200A in which a cloud agent service is provided by the system described in FIG. 1 herein. As illustrated, the environment 200A may include cloud provider A, 104A cloud provider B 104B, region 1 106A, region 2 106B, VPC(s) 110, VNET(s) 112, dashboard 126, vPoP 1 118A, and vPoP 2 118B. In some examples, one or more components of the dashboard 126 may be implemented in one or more of the service provider MCN account 212A and/or service provider MCN subscription 212B.

As illustrated, the dashboard 126 may include cloud agent 202. In some examples, the cloud agent 202 may comprise a cloud agent service (e.g., such as ThousandEyes) that enables tenants to monitor end-to-end connectivity across CSPs. As noted above, customers (e.g., tenants) may utilize the dashboard 126 to access the cloud agent 202 and configure and run test(s). As illustrated, the cloud agent 202 may include customer test(s) 204, MCN test(s) 206, customer data 208, and MCN data 210. In some examples, the dashboard 126 may be integrated as part of the NMS 124 described herein. In some examples, the dashboard 126 may be integrated into a security cloud service (e.g., such as Cisco's Secure Connect, Secure Access, etc.)

The customer test(s) 204 may include probe(s) configured by tenant(s) and may be associated with each particular tenant. As noted above, the customer test(s) 204 may include probes of any connection between network elements of a customer account across CSPs. MCN test(s) 206 may comprises test(s) generated and configured by the service provider (e.g., Cisco) and may be configured to test one or more of edge-to-edge connectivity, edge to end connectivity, infrastructure, etc. within and across the multi-cloud mesh 102. Customer data 208 may comprise data associated with each respective tenant, including but not limited to customer account data, customer network data, statistics, BGP data, traffic flow data (e.g., such as NetFlow data), topology data, etc. MCN data 210 may include, but is not limited to, data associated with the service provider and the multi-cloud mesh 102, such as infrastructure data, connectivity data, infrastructure statistics, BGP data, traffic flow data (e.g., such as NetFlow data), account data, vPoP data, etc. As noted above, the dashboard 126 may be integrated as part of the NMS 124 and/or provided via an application (e.g., such as a ThousandEyes dashboard) operating on a user device of a user of a tenant account.

The dashboard 126 may include intelligence component 236. In some examples, the intelligence component may be configured to identify address(es) of customer's network to use when performing a test. For instance, the intelligence component may be configured as part of the NMS and/or deployed as part of a CNHE, a vPoP, etc. within the multi-cloud mesh. The intelligence component may be configured to receive customer data, statistics, etc. from the vPoPs. The intelligence component may be configured to monitor connections within a customer account at a CSP. In some examples, the intelligence component may be configured to determine (e.g., based on the data, access, monitoring the connections, etc.) one or more subnet(s) and/or IP address(es) within the customer account of the CSP that are unused or not currently being used by the customer account. In some examples, the intelligence component may select one of the unused subnet(s)/IP address(es) that can be used by a vPoP when performing a probe via an instance of the cloud agent. In this example, when the dashboard sends a test to a vPoP to be performed, the CNHE/vPoP may send the probe using the unused subnet/IP address as the source address for the probe. Thus, the system may ensure that the probe that is sent appears to be running on a VPC or VNET within the customer account of a CSP and may therefore apply the appropriate firewall policies and/or other policies to the probe. In some examples, the system is configured to utilize the unused subnet/IP address temporarily (e.g., tests that are run a few times, but are not permanent or run consistently over a long period of time (e.g., weeks, months, etc.). In other examples, such as where a test is run consistently over a long period of time, the system may reserve a subnet/IP address. In this example, the system may create a network interface to reserve the IP address on the subnet from the customer account and may use the IP address for the probe associated with the subnet. Thus, by reserving a single IP address for each subnet within the customer account the system can perform probing for all of the subnets across CSPs.

In some examples, such as where a probe is configured to test from an external or remote application into an edge of the customer account of the CSP, the system may provide the unused subnet/IP address to the external or remote application for use when sending the probe. In this example, the system may configure the probe to include a functionality that enables the vPoP to answer the probe.

In some examples, the intelligence component may be configured to utilize one or more artificial intelligence and/or machine learning model(s) to generate recommendation(s) of test(s) and/or configure test(s) on behalf of the customer. For instance, the intelligence component may be configured to analyze the data (e.g., using the model(s)) and determine patterns or intent of connectivity (which is enforced by the CNHEs) between the CSPs for a customer. The intelligence component may, based on the patterns and/or intent of connectivity generate a set of tests to recommend to the customer to use to test if a configuration is or is not working as designed. As an example, the intelligence component may generate a recommendation of a test to run in response to someone trying to change or update a tag within a customer account. In other examples, the intelligence component may recommend the customer adopt a rule that where the customer creates a new application, the system may run test(s) the next day to make sure connections are working correctly. In some examples, the intelligence component may be configured to automatically turn tests on or off. For instance, the tests to check connections of an application can be turned on when the system detects a new application is deployed or connected to the multi-cloud mesh. In another example, such as where the customer configures a change to one or more firewall rules, the intelligence component may automatically turn on the tests for a set period of time (e.g., 20 minutes, 30 minutes, etc.) and then automatically turn the tests off.

The dashboard 126 may be connected to one or more service provider networks of the multi-cloud mesh 102. For instance, the dashboard 126 is connected to service provider MCN account 212A and service provider MCN subscription 212B. The service provider MCN account 212A may correspond to a service provider network owned by the service provider (e.g., Cisco) that operates in region 1 106A of cloud provider A 104A (e.g., AWS region 1). The service provider MCN subscription 212B may correspond to another service provider network owned by the service provider (e.g., Cisco) that operates in region 1 106A of cloud provider B 104B (e.g., Azure region 1). In some examples, one or more components of the dashboard 126 may be implemented in one or more of the

Service provider MCN account 212A may include vPoP orchestration 214A. In some examples, the vPoP orchestration 214A (and/or vPoP orchestration 214B) may be implemented by the dashboard 126. The vPoP orchestration 214A may be configured to instantiate vPoP(s) 118 within the service provider MCN account 212A within the multi-cloud mesh 102. In some examples, the vPoP orchestration 214A may correspond to a template component (not illustrated) that is configured to utilize cloud formation templates to automatically set up the connections between the VPCs/VNETs by configuring site-to-site VPN connections, virtual gateways, customer gateways, etc., and hooking them back to the multi-cloud mesh (e.g., by connecting them to vPoPs). In some examples, the system may set up traffic between the VPC and a vPoP, where the system optimizes the connection (e.g., based on priority of traffic, cost, quality of service (QoS), etc.) for the customer. The system may also set up the routing tables within the customer network and the multi-cloud mesh. Accordingly, the system may automatically discover and create connections between the customer network and the MCN without the customer having to assign addresses, configure connections, utilize specialized networking teams, etc.

In some examples, the vPoP orchestration 214A may be configured to monitor connection(s) between CNHE 216 vPoP 1 118A and tenant account(s) within cloud provider A 104A. Service provider MCN account 212A may also include availability zone 1 228, which may correspond to a building, a complex of buildings, data center(s), etc. of cloud provider A. Within availability zone 1 228, the service provider MCN account 212A may deploy a CNHE 216 vPoP 1 118A, which is configured to execute agent instance(s) 218 of the cloud agent 202. The agent instance(s) 218 may comprise probe(s) 220, which may be configured to be deployed to test connectivity on behalf of tenant accounts (e.g., such as tenant A account 230A, tenant B account 230B) and/or the service provider MCN account 212A. As described in greater detail below, the CNHE 216 vPoP 1 118A may include a control plane 222 and data plane 224. The service provider MCN account 212A may collect data 226A, which may comprise customer data 208 and/or MCN data 210, and may send the data to the dashboard 126 in real-time. In some examples, service provider MCN account 212A may utilize BGP or any other suitable protocols.

As illustrated, the CNHE 216 vPoP 1 118A may be connected to VPC(s) 110 of tenant A account 230A and tenant B account 230B. Each tenant account may correspond to a customer account of a CSP. For instance, the tenant A account 230A may correspond to a cloud network owned by tenant A that runs in cloud provider A 104A region 1 106A (e.g., AWS region 1). As illustrated, each of the VPC(s) 110 may be connected to one or more subnet(s) 232. While not illustrated, each subnet may comprise a plurality of IP address(es).

As illustrated, cloud provider B 104B region 1 106A may include a service provider MCN subscription 212B, which may correspond to a network owned by the service provider (e.g., Cisco) that operates within cloud provider B 104B. The service provider MCN subscription 212B may include vPoP orchestration 214B. The vPoP orchestration 214B may be configured to instantiate vPoP(s) 118 within the service provider MCN subscription 212B within the multi-cloud mesh 102. The vPoP orchestration 214B may be configured to monitor connection(s) between CNHE 216 vPoP 2 118B and tenant account(s) within cloud provider B 104B. Service provider MCN subscription 212B may also include availability zone 1 228, which may correspond to a building, a complex of buildings, data center(s), etc. of cloud provider B 104B. Within availability zone 1 228, the service provider MCN subscription 212B may include a CNHE 216 vPoP 2 118B, which is configured to execute agent instance(s) 218 of the cloud agent 202 within cloud provider B 104B. The agent instance(s) 218 may comprise probe(s) 220, which may be configured to be deployed to test connectivity on behalf of tenant accounts (e.g., such as tenant A subscription 234A, tenant B subscription 234B) and/or the service provider MCN account 212A. As described in greater detail below, the CNHE 216 vPoP 1 118A may include a control plane 222 and data plane 224. The service provider MCN subscription 212B may collect data 226B, which may comprise customer data 208 and/or MCN data 210, and may send the data to the dashboard 126 in real-time. In some examples, service provider MCN subscription 212B may utilize BGP or any other suitable protocols.

As illustrated, the CNHE 216 vPoP 2 118B may be connected to VPC(s) 110 of tenant A subscription 234A and tenant B subscription 234B. Each tenant subscription may correspond to a customer account of a CSP. For instance, the tenant A subscription 234A may correspond to a cloud network subscription that is owned by tenant A that runs in cloud provider B 104B region 1 106A (e.g., Azure region 1). As illustrated, each of the VPC(s) 110 may be connected to one or more subnet(s) 232. While not illustrated, each subnet may comprise a plurality of IP address(es).

Accordingly, a user of the tenant A account 230A may configure customer test(s) 204 via the dashboard 126, which may be deployed to CNHE vPoP 1 118A to run. The customer test(s) 204 may probe connectivity between any network element within the accounts (e.g., networks) of Tenant A, including Tenant A account 230A, tenant A subscription 234A, etc., to provide end-to-end connectivity monitoring across CSPs.

FIG. 2B illustrates a system-architecture diagram of an environment 200B that illustrates exemplary probe pathways enabled by the techniques described herein. As illustrated, the environment 200B may include cloud provider A 104A, cloud provider B 104B, region 1 106A, region 2 106B, VPC 1 110A, VPC 2 110B, VPC N 110N, VNET 1 112A, VNET 2 112B, VNET 3 112C, VNET N 112N, subnet(s) 232, availability zone 1 228, tenant A account 230A, tenant B account 230B, tenant A subscription 234A, tenant B subscription 234B, service provider MCN account 212A, service provider MCN subscription 212B, CNHE 216 vPoP 1 118A, CNHE 216 vPoP 2 118B, agent instance 1 218A, agent instance 2 218B, probe 1 220A, probe 2 220B, probe 3 220C, probe 4 220D, probe N 220N, dashboard 126, cloud agent 202, customer test(s) 204, MCN test(s) 206, customer data 208, MCN data 210, and intelligence component 236.

As noted above, a user of the service provider (e.g., such as Cisco) may utilize the dashboard 126 to access cloud agent 202 and configure MCN test(s) 204. For instance, at “1”, a probe may test a connection between probe 1 220A of CNHE 216 vPoP 1 118A of service provider MCN account 212A and probe 4 220D of CNHE 216 vPoP 2 118B of service provider MCN subscription 212B. As noted above, the service provider may configure various other MCN test(s) for connections between any network elements of the multi-cloud mesh 102. Pathway “1” may also be configured by a customer to ensure that the customer is able to connect across CSPs.

Similarly, a customer of a CSP (e.g., such as Cisco) may utilize the dashboard 126 to access cloud agent 202 and configure customer test(s) 204 for a particular tenant account. For instance, pathway “2” illustrates an example probe pathway that is executed by probe 2 220B and configured to test connectivity to subnet(s) 232 and VPC 1 110A in tenant A account 230A. In this example, pathway “2” may represent a probe that is sent by the multi-cloud mesh 102 to an IP address (or application, etc.) on subnet(s) 232. Accordingly, probe 2 220B may correspond to an initiator and the IP address on the subnet(s) 232 can be the answerer (e.g., indicating success or failure of the connection). As an example, pathway “2” may represent a probe testing connectivity of an application, such as Office 365 running on a user device. The customer can configure the test as a customer test in the cloud agent 202. The dashboard 126 may send the test to the CNHE 216 vPoP 1 118A. CNHE 216 vPoP 1 118A may use an IP address associated with VPC 1 110A and/or subnet(s) 232 of Tenant A account 230A to send the probe from probe 2 220B. Accordingly, the probe (e.g., traffic and/or connection request) may appear to Office 365 as it is originating from an IP address running on VPC 1 110A. Accordingly, the service provider MCN account 212A may collect data 226A indicating whether the connection and/or probe was successful, which may further indicate that VPC 1 110A is connected, as well as route data within the tenant A account 230A to reach Office 365.

Pathway “3” illustrates an example probe pathway configured to test connectivity to VPC 2 110B of tenant B account 230B. Accordingly, a customer of the tenant B account 230B may configure a test that traverses pathway “3” to ensure that VPC 2 110B is connected and running within the cloud provider A region 1 network.

Pathway “4” illustrates an example end-to-end pathway that is sent by probe N 220N and configured to test connectivity between the subnet(s) 232 of tenant B account 230B and the subnet(s) 232 of tenant B subscription 234B. As illustrated, pathway “4” sends a probe from the subnet(s) 232 of tenant B subscription 234B, through VNET 3 112C, CNHE vPoP 1 212A, VPC N 110N, and to subnet(s) 232 of the tenant B account 230B. Accordingly, pathway “4” may determine whether the customer can send traffic across CSPs.

It is understood that the pathways illustrated and described are examples only. Additional pathways and test(s) may be performed according to the techniques described herein.

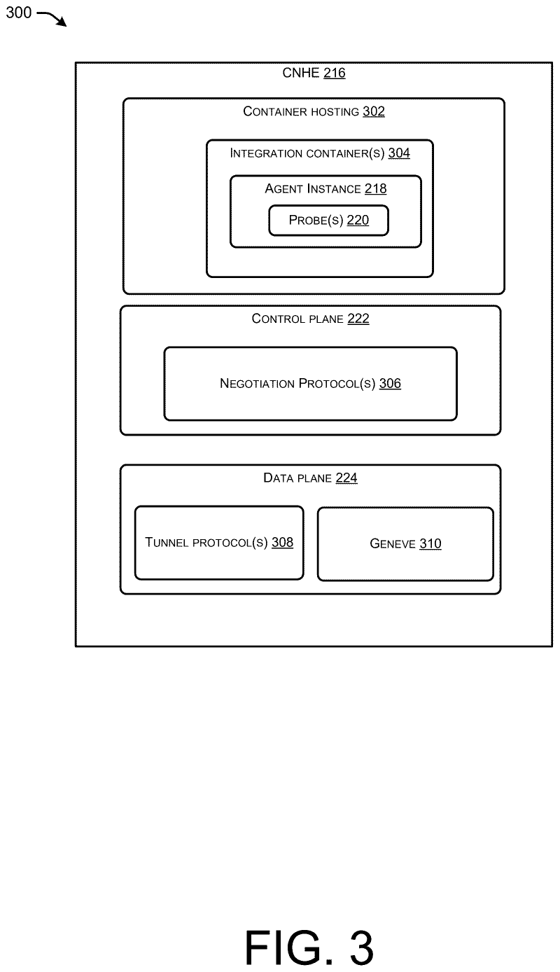

FIG. 3 illustrates an example environment 300 that includes a CNHE 216 that may be generated according to the techniques described herein. In some examples, the CNHE 216 may correspond to an integration with a cloud agent service, such as ThousandEyes. The CNHE 216 may be configured to support deep integrations, such as via the container hosting 302.

In some examples, the CNHE 216 may be generated by a dashboard 126 (not illustrated) (e.g., an NMS dashboard, a cloud agent service dashboard, etc.) and/or instantiated by a vPoP orchestration (not shown) within an account of the service provider (e.g., Cisco). In some examples, the CNHE 216 may integrate with the dashboard via integration container(s) 304. The integration container(s) 304 may be included as part of a container hosting 302 (e.g., such as Kubernetes container hosting or any other suitable platform). The integration container(s) 304 may comprise logic that programs the CNHE 216 to integrate a function to be performed within the MCN and connect with the dashboard 126. In some examples, the integration container(s) 304 may comprise container(s) built from the same Meraki code that is deployed in user device(s) of a customer associated with a tenant account. For instance, in the illustrated example, the integration container(s) 304 may include a container that contains logic to integrate agent instance 218 and probe(s) 220 of a cloud agent 202. Thus, the container(s) may appear as a cloud agent service in the dashboard 126 when accessed by a user device. As an example, when a user accesses the dashboard 126, the dashboard 126 may appear as a cloud service agent dashboard (e.g., such as a ThousandEyes dashboard).

In some examples, the integration container(s) 304 may correspond to AWS container(s). For instance, the container hosting 302 may include container(s) that add, within the control plane 222, per-tenant AWS container(s) for AWS-specific requirements. The dashboard 126 may utilize the per-tenant AWS container(s) and AWS specific requirements to configure the CNHE 216 for integration in AWS and gain statistics, customer data, and state data that the NMS 124 may use to generate cloud formation templates and configure an AWS account of a customer to connect to the multi-cloud mesh 102. In some examples, the dashboard 126 may configure the CNHE 216 to include expected AWS endpoint IP addresses, such that the CNHE 216 may provide automatic and tight DOS protection via the CNHE's front-end ACLs.

The CNHE 216 may comprise a containerized control plane 222. The control plane 222 may include negotiation protocol(s) 306. For instance, with regard to the Meraki deep integration, the negotiation protocol(s) 306 may correspond to Meraki's Punch (e.g., AutoVPN). In this example, the negotiation protocol(s) 306 may enable the CNHE 216 to connect to and/or integrate a registry (e.g., such as a Meraki registry) with the CNHE 216. In other examples, the negotiation protocol(s) 306 may include internet key exchange (IKE), border gateway protocol (BGP), etc. that the CNHE 216 may use to form connections with the dashboard 126 and/or VPCs of a customer account and/or cloud account.

The CNHE 216 may comprise a data plane 224. In some examples, the data plane 224 is pluggable. For instance, the data plane 224 may comprise tunnel protocol(s) 308 (e.g., encrypted tunnel protocol(s) or any other suitable tunnel protocol). In some examples, the tunnel protocol(s) 308 may include Meraki's AutoVPN protocol, IPsec, or any other suitable protocol to enable the CNHE 216 to form tunnel(s) with device(s), tenant VPC(s) (e.g., such as AWS VPCs, GCP VPCs, etc.), tenant VNET(s), and/or other CNHEs. The data plane 224 may utilize Geneve 310 (e.g., a network encapsulation protocol), or any other suitable protocol. It is understood that the CNHE 216 may include additional or fewer elements than those illustrated.

As noted above, the CNHE 216 may be configured to integrate the cloud agent 202 within the CNHE itself. For instance, the CNHE 216 may be configured to separate traffic via segmented routing of the traffic on a per tenant basis. The agent instance 218 may be configured to map time-based multiplexing for customer test(s) received from the cloud agent 202 of the dashboard 126 with the traffic segmentation performed by the CNHE 216. For instance, traffic segmented for each tenant performed by the CNHE may be mapped to the time division multiplexing used for scheduling probe(s) 220 by the cloud agent 202 and/or the agent instance 218. Thus, the CNHE 216, when deployed as a vPoP within the multi-cloud mesh 102, may allow a customer to schedule a test from a cloud agent 202 within their own network infrastructure rather than over the Internet alone. Accordingly, unlike existing techniques where a cloud agent could only deploy a probe via the Internet, the system may enable a cloud-based probe running in a CNHE of the multi-cloud mesh to access the entire customer environment for a particular tenant.

Accordingly, by utilizing the CNHE 216 (or any other suitable container), the system may be configured to build lightweight containers to integrate and deploy in CSPs, overlay management protocols (OMP), application centric infrastructure (ACI) networks, etc. For instance, the CNHE 216 may include containers configured for deployment in AWS, Azure, and/or GCP workflows.

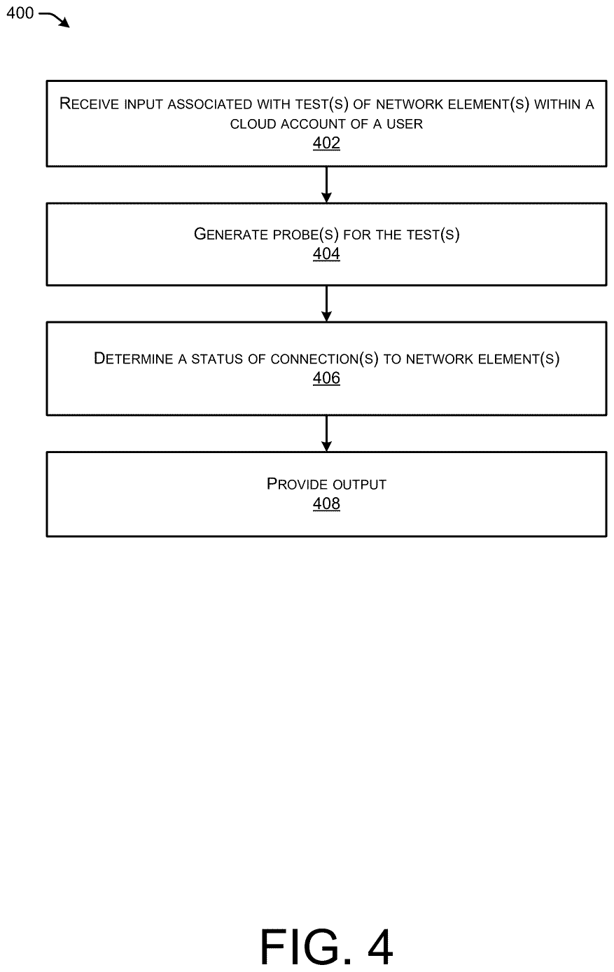

FIG. 4 illustrates a flow diagram of an example system 400 for providing an agentless end-to-end monitoring service in a multi-cloud network (MCN), according to the systems and techniques described herein. In some instances, one or more of the steps of system 400 may be performed by one or more devices (e.g., the NMS 124, vPoP(s), CNHE 216, etc.) that include one or more processors and one or more non-transitory computer-readable media storing computer-executable instructions that, when executed by the one or more processors, cause the one or more processors to perform operations of system 400. While the system is described as utilizing CNHEs, it is understood that the functions of the CNHEs may be performed by the vPoPs and/or any other suitable container or structure.

At 402, the system may receive input associated with test(s) of network element(s) within a cloud account of a user. For instance, the cloud account may correspond to a tenant account. In some examples, the tenant account is associated with one or more other CSPs, and wherein the test comprises testing the network element from the tenant account of the one or more other CSPs. In some examples, the input corresponds to instructions to run a probe of a connection to a network element. The probe may be sent end-to-end between tenant accounts across CSPs of the MCN. In some examples, the input may be received by a virtual point of presence (vPoP) within a service provider account of a cloud service provider of the MCN.

In some examples, the vPoP comprises an instance of a cloud agent configured to perform monitoring and probing of network elements. In some examples, the instance of the cloud agent is integrated as part of the vPoP, which is configured to perform the functions of a cloud native head end (CNHE). For instance, the vPoP may be configured to perform segmented routing of traffic from tenant accounts within the CSP and other CSPs of the MCN. The vPoP and/or CNHE may be configured to map segments of the traffic of each tenant to time division multiplexing performed by the instance of the cloud agent when scheduling the one or more probes.

In some examples, the network element includes a virtual private cloud (VPC), a virtual network (VNET), a subnet, an IP address, an application, a network interface, or an instance within the tenant account.

At 404, the system may generate probe(s) for the test(s). For instance, the vPoP may generate the probe(s) and/or execute the probe(s) for the test(s). In some examples, generating the one or more probes comprises: determining based on accessing the tenant account, an unused IP address associated with a virtual private cloud (VPC), a virtual network (VNET), or a subnet; and generating the one or more probes, where the one or more probes include the unused IP address as a source address of the one or more probes.

At 406, the system may determine a status of connection(s) to network element(s). For instance, the status of the connection comprises a failed connection or a successful connection. In some examples, the status of the connection may further comprise route data, topology data, statistics, traffic data, etc.

At 408, the system may provide output. For instance, the output may comprise one or more of an indication of a successful connection to the network element, an indication of a failed connection to the network element; route data associated with the connection to the network element in the tenant account, topology data associated with the tenant account, border gateway protocol (BGP) data, or statistical data associated with the tenant account.

In this way, the system may utilize a vPoP, CNHE (or any other suitable structure), etc. that, when deployed within the multi-cloud mesh 102, may allow a customer to schedule a test from a cloud agent 202 within their own network infrastructure rather than over the Internet alone. Accordingly, unlike existing techniques where a cloud agent could only deploy a probe via the Internet, the system may enable a cloud-based probe running in a vPoP and/or CNHE of the multi-cloud mesh to access the entire customer environment for a particular tenant.

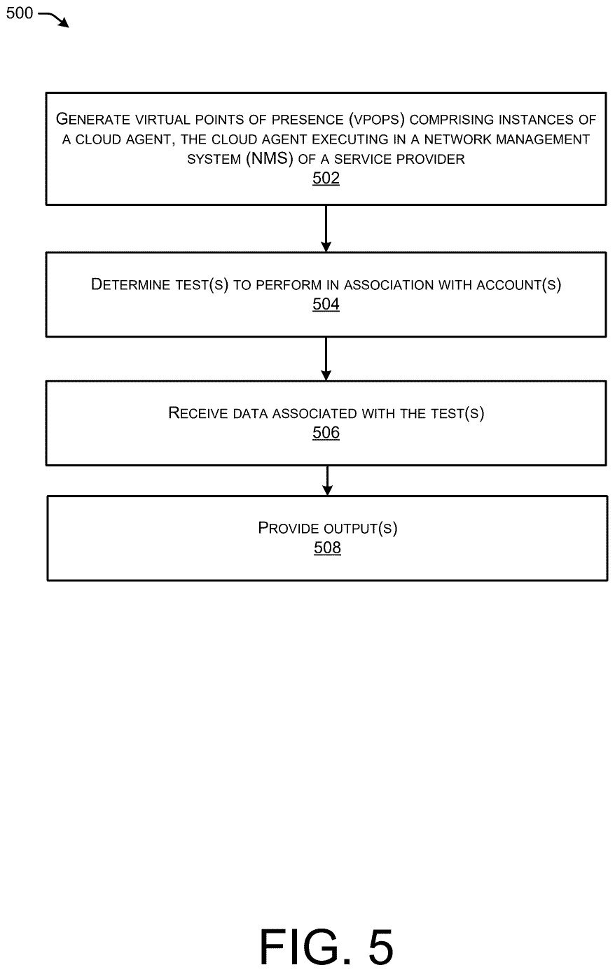

FIG. 5 illustrates a flow diagram of an example system 400 for providing an agentless end-to-end monitoring service in a network management system (NMS) of a multi-cloud network (MCN), according to the techniques described herein. In some instances, one or more of the steps of system 500 may be performed by one or more devices (e.g., the NMS 124, dashboard 126, etc.) that include one or more processors and one or more non-transitory computer-readable media storing computer-executable instructions that, when executed by the one or more processors, cause the one or more processors to perform operations of system 500.

At 502, the system may generate virtual points of presence (vPoPs) comprising instances of a cloud agent, the cloud agent executing in a NMS of a service provider. For instance, the cloud agent 202 may correspond to ThousandEyes and may be executing in a dashboard 126 associated with a service provider of the MCN (e.g., Cisco). As noted above, the vPoPs may comprise CNHEs 216 that are multi-tenanted and configured to perform segmented routing of traffic between tenants. The CNHEs may also be configured to map the segmentations of traffic to time division multiplexing performed by the instance of the cloud agent when scheduling the one or more probes. While the system is described as utilizing CNHEs, it is understood that the functions of the CNHEs may be performed by the vPoPs and/or any other suitable container or structure.

At 504, the system may determine test(s) to perform in association with account(s). For instance, the test(s) may comprise synthetic tests that are performed by the instances of the cloud agent executing in the vPoPs within the MCN. In some examples, the test(s) may correspond to testing connection(s) to network element(s) within a tenant account. For instance, the tenant account may correspond to a customer of the service provider and/or a service provider account.

At 506, the system may receive data associated with the test(s). In some examples, the data may comprise customer data 208 and/or MCN data 210. In some examples, the data may include status indications of whether the test(s) were successful or failed.

At 508, the system may provide output(s). For instance, the output(s) may include a message in association with a tenant account. In some examples, the message may include a status of the connection(s). In some examples, the message may comprise an alert associated with a failure of the one or more connections, an indication of success of the one or more connections, a recommendation of one or more rule or one or more additional tests.

In some examples, the system may determine, based on the data and additional data associated with the tenant account across cloud service providers (CSPs) of the MCN, a recommendation of one or more additional tests and one or more conditions for executing the one or more additional tests to apply to the tenant account. The system may receive, from a user of the tenant account, acceptance of the recommendation. The system may monitor the tenant account across the CSPs and automatically perform the one or more additional tests when the one or more conditions are met.

In this way, the system may provide end-to-end monitoring of connection(s) for tenant accounts across CSPs. For instance, by deploying vPoPs that include instances of a cloud agent service, the system may enable the cloud agent instance to access the customer's private network, instead of being limited to the Internet. Moreover, by running the vPoPs within the multi-cloud mesh, the system may reduce the overhead of maintaining infrastructure and streamline connectivity issues of tenant accounts by identifying connectivity failures anywhere in the tenant account, in any CSP. Further, by reserving an IP address or utilizing an unused IP address, the system may improve security, by ensuring the probe(s) are routed through the appropriate firewalls within the customer network. Further, by automatically generating recommendations of test(s) and/or rule(s) to apply to test(s), the system may automatically configure test(s) and/or policies for the tenant account that can improve security of the tenant account (e.g., such as turning tests on/off after a firewall rule change is applied), by enabling the tenant account to identify potential security issues with the firewall rule change, and remediate the security issues faster.

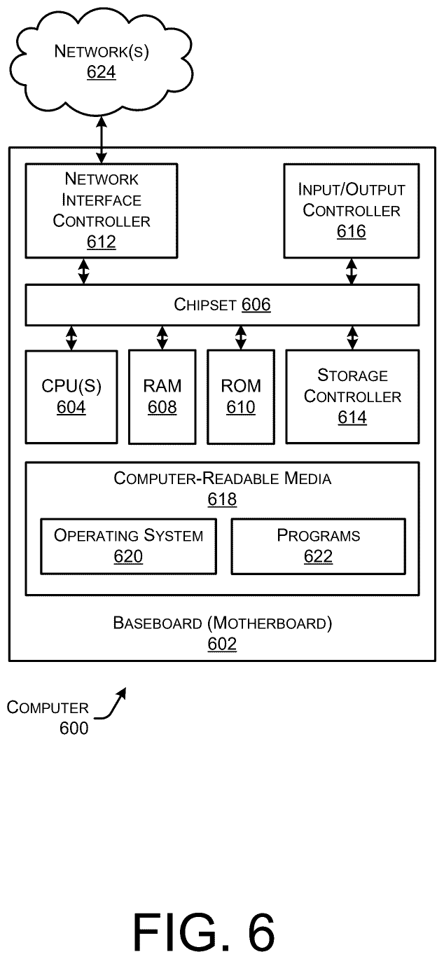

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer may, in some examples, correspond to a NMS 124, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs 604”) operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as network(s) 624. The network(s) 624 may correspond to internet 122, the multi-cloud mesh 102, etc. The chipset 606 can include functionality for providing network connectivity through a NIC 612, such as a gigabit Ethernet adapter. The NIC 612 is capable of connecting the computer 600 to other computing devices over the network(s) 624. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the NMS 124, and/or any components included therein, may be supported by one or more devices similar to computer 600. Stated otherwise, some or all of the operations performed by the NMS 124, and/or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-6. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

As described herein, the computer 600 may comprise one or more of a NMS 124, and/or any other device. The computer 600 may include one or more hardware processors (processor(s), such as CPUs 604) configured to execute one or more stored instructions. The processor(s) may comprise one or more cores. Further, the computer 600 may include one or more network interfaces configured to provide communications between the computer 600 and other devices, such as the communications described herein as being performed by the NMS 124, and/or any other device. The network interfaces may include devices configured to couple to personal area networks (PANs), wired and wireless local area networks (LANs), wired and wireless wide area networks (WANs), SDWANs, and so forth. For example, the network interfaces may include devices compatible with Ethernet, Wi-Fi™, and so forth.

The programs 622 may comprise any type of programs or processes to perform the techniques described in this disclosure. For instance, the programs 622 may cause the computer 600 to perform techniques including receiving, by a virtual point of presence (vPoP) within a service provider account of a cloud service provider (CSP) of the MCN, input associated with a test of a network element within a tenant account of the CSP; generating, by the vPoP, one or more probes associated with the test of the network element; sending, by the vPoP and to the network element within the tenant account, the one or more probes; determining, based on the one or more probes, a status of a connection to the network element; and sending, based on the status, output to a dashboard of a service provider of the MCN. The computer 600 may also perform techniques including generating virtual points of presence (vPoPs) comprising instances of a cloud agent, the cloud agent executing within the NMS; determining a test of one or more connections associated with a tenant account, the test being performed by an instance of the cloud agent at a vPoP; receiving data associated with execution of the test by the vPoP; determining a status of the tenant account based on the data; and outputting a message in association with the tenant account, the message including the status.

In this way, the computer 600 may provide end-to-end monitoring of connection(s) for tenant accounts across CSPs. For instance, by deploying vPoPs that include instances of a cloud agent service, the system may enable the cloud agent instance to access the customer's private network, instead of being limited to the Internet. Moreover, by running the vPoPs within the multi-cloud mesh, the system may reduce the overhead of maintaining infrastructure and streamline connectivity issues of tenant accounts by identifying connectivity failures anywhere in the tenant account, in any CSP. Further, by reserving an IP address or utilizing an unused IP address, the system may improve security, by ensuring the probe(s) are routed through the appropriate firewalls within the customer network. Further, by automatically generating recommendations of test(s) and/or rule(s) to apply to test(s), the system may automatically configure test(s) and/or policies for the tenant account that can improve security of the tenant account (e.g., such as turning tests on/off after a firewall rule change is applied), by enabling the tenant account to identify potential security issues with the firewall rule change, and remediate the security issues faster.

Moreover, the computer 600 may utilize a CNHE that, when deployed as a vPoP within the multi-cloud mesh 102, may allow a customer to schedule a test from a cloud agent 202 within their own network infrastructure rather than over the Internet alone. Accordingly, unlike existing techniques where a cloud agent could only deploy a probe via the Internet, the system may enable a cloud-based probe running in a CNHE of the multi-cloud mesh to access the entire customer environment for a particular tenant.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method of providing an agentless end-to-end monitoring service in a multi-cloud network (MCN), comprising:
receiving, by a virtual point of presence (vPoP) within a service provider account of a cloud service provider (CSP) of the MCN, input associated with a test of a network element within a tenant account of the CSP;
generating, by the vPoP, one or more probes associated with the test of the network element;
sending, by the vPoP and to the network element within the tenant account, the one or more probes;
determining, based on the one or more probes, a status of a connection to the network element; and
sending, based on the status, output to a dashboard of a service provider of the MCN.

2. The method of claim 1, wherein the vPoP is configured as a head end and comprises an instance of a cloud agent configured to perform monitoring and probing of network elements.

3. The method of claim 2, wherein the instance of the cloud agent is configured to perform segmented routing of traffic from tenant accounts within the CSP and other CSPs of the MCN.

4. The method of claim 3, wherein the vPoP is configured to map segments of the traffic of each tenant to time division multiplexing performed by the instance of the cloud agent when scheduling the one or more probes.

5. The method of claim 1, wherein the tenant account is associated with one or more other CSPs, and wherein the test comprises testing the network element from the tenant account of the one or more other CSPs.

6. The method of claim 1, wherein the output comprises one or more of an indication of a successful connection to the network element, an indication of a failed connection to the network element; route data associated with the connection to the network element in the tenant account, topology data associated with the tenant account, border gateway protocol (BGP) data, or statistical data associated with the tenant account.

7. The method of claim 1, wherein the status of the connection comprises a failed connection or a successful connection.

8. The method of claim 1, wherein the network element includes a virtual private cloud (VPC), a virtual network (VNET), a subnet, an IP address, an application, a network interface, or an instance within the tenant account.

9. The method of claim 1, wherein generating the one or more probes comprises:
determining based on accessing the tenant account, an unused IP address associated with a virtual private cloud (VPC), a virtual network (VNET), or a subnet; and
generating the one or more probes, where the one or more probes include the unused IP address as a source address of the one or more probes.

10. A system comprising:
one or more processors; and
one or more computer-readable media storing instructions that, when executed by the one or more processors, cause the one or more processors to perform operations comprising:
receiving, by a virtual point of presence (vPoP) within a service provider account of a cloud service provider (CSP) of a multi-cloud network (MCN), input associated with a test of a network element within a tenant account of the CSP;
generating, by the vPoP, one or more probes associated with the test of the network element;
sending, by the vPoP and to the network element within the tenant account, the one or more probes;
determining a status of a connection to the network element; and
sending, based on the status, output to a dashboard of a service provider of the MCN.

11. The system of claim 10, wherein the vPoP is configured as a head end and comprises an instance of a cloud agent configured to perform monitoring and probing of network elements.

12. The system of claim 11, wherein:
the instance of the cloud agent is configured to perform segmented routing of traffic from tenant accounts within the CSP and other CSPs of the MCN; and
the vPoP is configured to map segments of the traffic of each tenant to time division multiplexing performed by the instance of the cloud agent when scheduling the one or more probes.

13. The system of claim 10, wherein the tenant account is associated with one or more other CSPs, and wherein the test comprises testing the network element from the tenant account of the one or more other CSPs.

14. The system of claim 10, wherein the output comprises one or more of an indication of a successful connection to the network element, an indication of a failed connection to the network element; route data associated with the connection to the network element in the tenant account, topology data associated with the tenant account, border gateway protocol (BGP) data, or statistical data associated with the tenant account.

15. The system of claim 10, wherein the network element includes a virtual private cloud (VPC), a virtual network (VNET), a subnet, an IP address, an application, a network interface, or an instance within the tenant account.

16. The system of claim 10, wherein generating the one or more probes comprises:
determining based on accessing the tenant account, an unused IP address associated with a virtual private cloud (VPC), a virtual network (VNET), or a subnet; and
generating the one or more probes, where the one or more probes include the unused IP address as a source address of the one or more probes.

17. A method of providing an agentless end-to-end monitoring service in a network management system (NMS) of a multi-cloud network (MCN), comprising:
generating virtual points of presence (vPoPs) comprising instances of a cloud agent, the cloud agent executing within the NMS;
determining a test of one or more connections associated with a tenant account, the test being performed by an instance of the cloud agent at a vPoP;
receiving data associated with execution of the test by the vPoP;
determining a status of the tenant account based on the data; and
outputting a message in association with the tenant account, the message including the status.

18. The method of claim 17, wherein the tenant account may comprise a user account associated with a customer of a service provider of the NMS or a service provider account of the service provider of the NMS.

19. The method of claim 17, further comprising:
determining, based on the data and additional data associated with the tenant account across cloud service providers (CSPs) of the MCN, a recommendation of one or more additional tests and one or more conditions for executing the one or more additional tests to apply to the tenant account;
receiving, from a user of the tenant account, acceptance of the recommendation;
monitoring the tenant account across the CSPs; and
automatically performing the one or more additional tests when the one or more conditions are met.

20. The method of claim 17, wherein the message comprises an alert associated with a failure of the one or more connections, an indication of success of the one or more connections, a recommendation of one or more rule or one or more additional tests.
